(19) United States
(12) Patent Application Publication
(10) Pub. No.: US 2025/0087706 A1
(43) Pub. Date: Mar. 13, 2025

(54) ALL-SOLID-STATE SECONDARY BATTERY INCLUDING ELASTOMER

(71) Applicant: Samsung Electronics Co., Ltd., Suwon-si (KR)

(72) Inventors: Myungjin Lee, Suwon-si (KR); Hyunbum Kang, Suwon-si (KR); Taehee Kim, Suwon-si (KR); Jusik Kim, Suwon-si (KR); Gaehwang Lee, Suwon-si (KR)

(21) Appl. No.: 18/433,653

(22) Filed: Feb. 6, 2024

(30) Foreign Application Priority Data
Sep. 8, 2023 (KR) 10-2023-0119615

(51) Int. Cl. H01M 4/66; H01M 4/02; H01M 4/131; H01M 4/133; H01M 10/0525; H01M 10/0562; H01M 10/42

(52) U.S. Cl. CPC H01M 4/668; H01M 4/131; H01M 4/133; H01M 10/0562; H01M 10/4235; H01M 2004/021; H01M 2004/027; H01M 10/0525; H01M 2300/0071

(57) ABSTRACT

An all-solid-state secondary battery includes: a positive electrode layer including a positive electrode active material layer, and a positive electrode current collector; a negative electrode layer including a negative electrode current collector, and a negative electrode active material layer; a solid electrolyte layer; and an elastomeric member including an elastomer and disposed inside the negative electrode current collector or the positive electrode current collector, wherein the negative electrode current collector and the negative electrode active material layer are disposed side by side in a thickness direction of the negative electrode layer, the positive electrode current collector and the positive electrode active material layer are disposed side by side in a thickness direction of the positive electrode layer, and the negative electrode current collector or the positive electrode current collector surrounds an outer surface of the elastomeric member.

### CROSS-REFERENCE TO RELATED APPLICATION

This application claims priority to Korean Patent Application No. 10-2023-0119615, filed on Sep. 8, 2023, in the Korean Intellectual Property Office, and all the benefits accruing therefrom under 35 U.S.C. § 119, the content of which is incorporated by reference herein in its entirety.

### BACKGROUND

### 1. Field

The disclosure relates to an all-solid-state secondary battery and a method of manufacturing the same.

### 2. Description of the Related Art

Recently, batteries with high energy density and safety have been actively developed in response to industrial demand. For example, lithium-ion batteries are used in the field of automobiles, as well as in the field of information-related equipment and communications equipment. Safety is particularly important in vehicle applications.

Since a currently available lithium-ion battery employs an electrolyte containing a combustible organic solvent, overheating and fires are possible when a short circuit occurs. Accordingly, an all-solid-state battery using a solid electrolyte instead of a liquid electrolyte has been proposed.

An all-solid-state secondary battery may significantly reduce the possibility of fires or explosions even when a short circuit occurs. Therefore, an all-solid-state battery may significantly increase safety compared to a lithium-ion battery including a liquid electrolyte. Nonetheless, there remains a need for an improved all-solid-state battery.

### SUMMARY

Provided is an all-solid-state secondary battery including an elastomeric member including an elastomer.

Additional aspects will be set forth in part in the description which follows and, in part, will be apparent from the description, or may be learned by practice of the presented embodiments of the disclosure.

According to an aspect of an embodiment, an all-solid-state secondary battery includes
a positive electrode layer including a positive electrode active material layer, and a positive electrode current collector;
a negative electrode layer spaced apart from the positive electrode layer and including a negative electrode current collector, and a negative electrode active material layer;
a solid electrolyte layer disposed between the positive electrode layer and the negative electrode layer; and
an elastomeric member including an elastomer and disposed inside at least one of the negative electrode current collector or the positive electrode current collector, wherein the negative electrode current collector and the negative electrode active material layer are disposed side by side in a thickness direction of the negative electrode layer,
the positive electrode current collector and the positive electrode active material layer are disposed side by side in a thickness direction of the positive electrode layer, and
at least one of the negative electrode current collector or the positive electrode current collector surrounds an outer surface of the elastomer.

At least one of the negative electrode current collector or the positive electrode current collector may surround all outer of the elastomeric member.

The elastomeric member may include at least one of a polymer or a polymer metal composite.

The elastomeric member may be disposed inside the negative electrode current collector and may have an elastic restoring force.

The elastomeric member may have a Young's modulus of 10 MPa or less.

The elastomeric member may have a Young's modulus of 5 MPa or less.

A thickness of the elastomeric member may be about 20 micrometers (μm) to about 100 μm.

At least one of the negative electrode current collector or the positive electrode current collector may include a metal oxide, a metal, or a combination thereof.

The negative electrode active material layer may include a carbon-containing negative electrode active material, a mixture of a carbon-containing negative electrode active material and at least one of a metal or a metalloid, a composite of a carbon-containing negative electrode active material and at least one of a metal or a metalloid, or a combination thereof.

A thickness of the negative electrode current collector may be about 100 nanometers (nm) to about 30 μm.

The metal oxide may include FeOₓ (0<x≤2), FeO, FeO₂, Fe₂O₃, Fe₃O₄, AlOₓ (0<x≤2), Al₂O₃, SnOₓ (0<x≤2), SnO, GeOₓ (0<x≤2), GeO, SiOₓ (0<x≤2), SiO, SiO₂, ScOₓ (0<x≤2), Sc₂O₃, CrOₓ (0<x≤5), CrO, Cr₂O₃, CrO₂, CrO₃, CrO₅, MnOₓ (0<x≤3), MnO, Mn₂O₃, Mn₃O₄, MnO₂, MnO₃, CoOₓ (0<x≤2), CoO, Co₂O₃, Co₃O₄, NiOₓ (0<x≤2), NiO, Ni₂O₃, CuOₓ (0<x≤2), CuO, CuO₂, Cu₂O₃, Cu₂O, or a combination thereof.

The metal may be derived from the metal oxide, and the metal may include at least one of Cu, Ni, Ag, Fe, Ti, or Cr.

A first positive electrode active material layer, a first solid electrolyte layer, a first negative electrode layer, and a first elastomeric member are disposed on a first surface of the positive electrode current collector,
a second positive electrode active material layer, a second solid electrolyte layer, a second negative electrode layer, and a second elastomeric member are disposed on a second surface of the positive electrode current collector, the second surface being opposite to the first surface of the positive electrode current collector, and
the first positive electrode active material layer, the first solid electrolyte layer, the first negative electrode layer, and the first elastomeric member are disposed opposite to the second positive electrode active material layer, the second solid electrolyte layer, the second negative electrode layer, and the second elastomeric member, respectively, with respect to the positive electrode current collector.

The solid electrolyte layer may include an oxide-containing solid electrolyte, a sulfide-containing solid electrolyte, a polymer-containing solid electrolyte, or a combination thereof.

The oxide-containing solid electrolyte may include Li_{1+x+y}AlₓTi₂₋ₓSi_{y}P_{3-y}O₁₂ (0<x<2, 0≤y<3), BaTiO₃, Pb(ZrₚTi₁₋ₚ)O₃ (PZT, 0≤p≤1), Pb₁₋ₓLaₓZr_{1-y}Ti_{y}O₃ (PLZT, 0≤x<1, 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₚGa₁₋ₚ)ₓ(Ti_{q}Ge_{1-q})₂₋ₓSi_{y}P_{3-y}O₁₂ (0≤x≤1, 0≤y≤1, 0≤p≤1, and 0≤q≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, 0≤x≤10), Li₃₊ₓLa₃Zr_{2-y}M_{y}O₁₂ (M doped LLZO, M=Ga, W, Nb, Ta, Al, or a combination thereof, 0≤x≤10, 0<y<2), Li₇La₃Zr₂₋ₓTaₓO₁₂ (0<x<2, LLZ-Ta), or a combination thereof.

The oxide-containing solid electrolyte may include Li₇La₃Zr₂O₁₂, Li_{6.5}La₃Zr_{1.5}Ta_{0.5}O₁₂, Li_{1.3}Al_{0.3}Ti_{1.7} (PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, or a combination thereof.

The sulfide-containing solid electrolyte may include Li₂S—P₂S₅, Li₂S—P₂S₅—LiX (X is an halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each a positive number, and Z is one of Ge, Zn, Ga, or a combination thereof), Li₂S—GeS₂, Li₂S—SiS₂—Li₃PO₄, Li₂S—SiS₂—LiₚMO_{q} (p and q are each a positive number, and M is P, Si, Ge, B, Al, Ga, In, or a combination thereof).

The elastomeric member may include at least one rigid structure and at least one flexible structure.

A weight ratio of the rigid structure to the flexible structure may be less than 1.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an embodiment of an all-solid-state secondary battery;

FIG. 2 is a cross-sectional view of an embodiment of an all-solid-state secondary battery;

FIGS. 3A to 3C are each a cross-sectional view illustrating an all-solid-state secondary battery;

FIGS. 4A and 4B are each a cross-sectional view illustrating an all-solid-state secondary battery;

FIG. 5 is a graph of potential (volts, V) vs capacity density (milliampere·hours per square centimeter, mAh/cm²) illustrating charge and discharge characteristics according to capacity per unit area used in Example 1 and Comparative Examples 1 and 2; and

FIG. 6 is a graph of capacity density (mAh/cm²) vs number of cycles and coulombic efficiency (percent, %) vs number of cycles illustrating lifespan characteristics according to the number of cycles used in Examples 1 and 2 and Comparative Examples 1 and 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. The size of each component in the drawings may be exaggerated for clarity and convenience of description. Meanwhile, embodiments described below are merely illustrative, and various modifications are possible from these embodiments. As used herein, the term “and/or” includes any and all combinations of one or more of the associated listed items. Expressions such as “at least one of,” when preceding a list of elements, modify the entire list of elements and do not modify the individual elements of the list.

Hereinafter, the term “upper portion” or “on” may also include “to be present on the top, bottom, left or right portion on a non-contact basis” as well as “to be present just on the top, bottom, left or right portion in directly contact with”. It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The singular expression includes plural expressions unless the context clearly implies otherwise. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. “At least one” is not to be construed as limiting “a” or “an.” “Or” means “and/or.” As used herein, the term “and/or” includes any and all combinations of one or more of the associated listed items.

In addition, when a part “includes” a component, this means that it may further include other components, not excluding other components unless otherwise opposed. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The use of the term “the” and similar indicative terms may correspond to both singular and plural. Unless there is clear order or contrary description of the steps constituting the method, these steps may be performed in the appropriate order, and are not necessarily limited to the order described.

Further, the terms “unit”, “module” or the like mean a unit that processes at least one function or operation, which may be implemented in hardware or software or implemented in a combination of hardware and software.

The connection or connection members of lines between the components shown in the drawings exemplarily represent functional connection and/or physical or circuit connections, and may be replaceable or represented as various additional functional connections, physical connections, or circuit connections in an actual device.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The use of all examples or illustrative terms is simply to describe technical ideas in detail, and the scope is not limited due to these examples or illustrative terms unless the scope is limited by the claims.

As an all-solid-state battery using lithium as a negative electrode active material, lithium that is precipitated in a negative electrode layer by charging may be used as an active material.

In such an all-solid-state secondary battery, when lithium precipitated in the negative electrode layer grows into a solid electrolyte layer, it may not only cause a short circuit in a battery, but may also cause a decrease in battery capacity.

An interface is formed between a solid electrolyte layer and a negative electrode layer in an all-solid-state secondary battery including an oxide-containing (i.e., oxide-based) solid electrolyte as a solid electrolyte. Lithium is locally precipitated at the interface between the solid electrolyte layer and the negative electrode layer, and the precipitated lithium is grown to pass through the solid electrolyte layer, thereby generating a short circuit of the battery or degrading cycle characteristics. In addition, a conventional negative electrode active material such as graphite or carbon black included in the negative electrode layer does not provide a wide contact area between the solid electrolyte layer and the negative electrode layer, or the diffusion rate of lithium passing through the negative electrode layer is slow. A short circuit occurs or cycle characteristics are degraded in the all-solid-state secondary battery including the negative electrode layer including the negative electrode active material.

It is desired to provide an all-solid-state secondary battery in which a short circuit is prevented during charging and discharging, a discharge capacity is increased, and a high-rate characteristic and a lifespan characteristic are improved.

In addition, it is desired to provide an all-solid-state secondary battery which mitigates internal pressure due to deposition and desorption of lithium, minimizes the generation and thickness change of a void that is likely to occur during deposition and desorption of lithium, and prevents the reduction of coulombic efficiency, which occurs due to a reduced ion conduction transmittance when the thickness of the negative electrode active material layer is reduced during discharge of the battery.

The present inventive concept described below may apply various transforms and may have various embodiments, and specific embodiments are illustrated in the drawings and described in detail. However, this is not intended to limit the inventive concept to a specific embodiment, and it should be understood that the present inventive concept includes all transforms, equivalents, or replacements included in the technical scope of the inventive concept.

The terms used hereinafter are used only to describe particular embodiments, and are not intended to limit the present inventive concepts. The singular expression includes plural expressions unless the context clearly implies otherwise. It will be further understood that the terms “comprise” or “have” used herein, specify the presence of stated features, numbers, steps, operations, elements, components, ingredients, materials, or combinations thereof, but do not preclude the presence or addition of one or more other features, numbers, steps, operations, elements, components, ingredients, materials, or combinations thereof. The symbol “/” used below may be interpreted as “and” depending on the situation or may be interpreted as “or”.

In the drawings, the thickness is enlarged or reduced in order to clearly express various layers and regions. Like parts are denoted by the same reference numerals throughout the specification. It will be further understood that when a layer, a film, an area, a plate, or the like is referred to as being “on” or “over” another part throughout the specification, it is not only a case located directly on the other but also a case in which there is another part in the middle. Through the whole disclosure, the terms first, second, etc. may be used to describe various components, but the components should not be limited by terms. Terms are used only for the purpose of distinguishing one component from another. In the present specification and drawings, elements having substantially the same functional configuration refer to the same reference numerals, and redundant descriptions thereof are omitted.

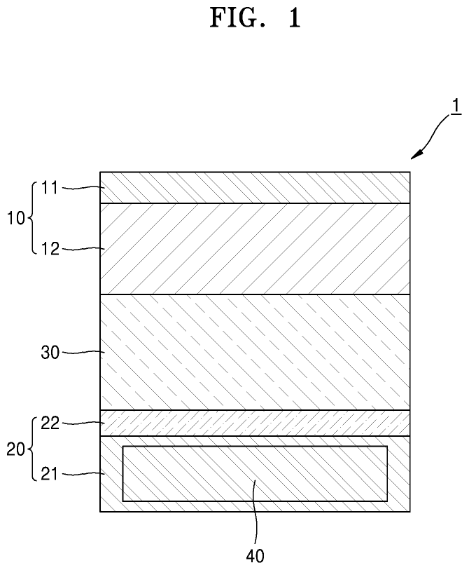

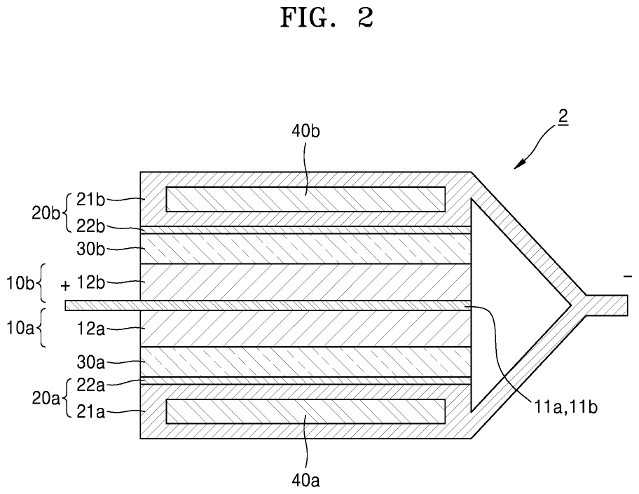

FIG. 1 is a cross-sectional view of an all-solid-state secondary battery according to an embodiment. FIG. 2 is a cross-sectional view of an all-solid-state secondary battery according to another embodiment.

Referring to FIG. 1, an all-solid-state secondary battery 1 includes a positive electrode layer 10, a negative electrode layer 20, and a solid electrolyte layer 30 disposed between the positive electrode layer and the negative electrode layer, wherein the negative electrode layer 20 includes a negative electrode current collector 21 and a negative electrode active material layer 22, and the positive electrode layer 10 may include a positive electrode current collector 11 and a positive electrode active material layer 12. In an aspect, the negative electrode active material layer faces the solid electrolyte layer, and the positive electrode active material layer faces the solid electrolyte layer. The negative electrode current collector 21 and the negative electrode active material layer 22 are included in the negative electrode layer 20, and may be disposed (e.g., arranged) side by side or sequentially arranged in a thickness direction of the negative electrode layer 20. An elastomeric member 40 comprising an elastomer may be disposed inside the negative electrode current collector 21, and at least one of the outer surfaces of the elastomeric member 40 may be in contact with the negative electrode current collector 21. In an aspect, at least one of the positive electrode current collector 11 or the negative electrode current collector 21 may surround all outer surfaces of the elastomeric member 40. Specifically, the outer surfaces of the elastomeric member 40 may include a total of four surfaces, and at least one of the positive electrode current collector 11 and the negative electrode current collector 21 may be in contact with and surround at least three of the four surfaces positioned outside the elastomeric member 40, or may be in contact with and surround all surfaces of the four surfaces. The positive electrode current collector 11 or the negative electrode current collector 21 may be formed to surround all the four surfaces located outside the elastomeric member 40. The positive electrode current collector 11 or the negative electrode current collector 21 may be formed so as to surround the outer surfaces of the elastomeric member 40, or the outer surface of the elastomeric member 40 may be formed so as to be embedded in the positive electrode current collector 11 or the negative electrode current collector 21.

The all-solid-state secondary battery according to an embodiment is a battery having a solid electrolyte layer between a positive electrode active material layer and a negative electrode active material layer, and simplifies an additional safety device desired for a battery comprising a liquid electrolyte layer having an electrolyte containing a combustible organic solvent. However, in the all-solid-state secondary battery, the thickness of the negative electrode active material layer may be changed during charging and discharging processes of the battery, and the thickness variation is relatively high compared to the secondary battery having the liquid electrolyte layer, and thus coulombic efficiency may be decreased. In particular, when discharging, the thickness of the negative electrode active material layer is reduced, so that the ion conductivity or electron conductivity is decreased, and thus coulombic efficiency may be decreased. In response, a predetermined buffer layer may be attached to relieve the internal pressure generated during lithium deposition and desorption in the process of charge and discharge of the battery and to prevent the reduction of the coulombic efficiency. The buffer layer is attached to the outside of the positive electrode and the negative electrode of the conventional all-solid-state secondary battery, which may cause a disadvantage in terms of energy density by increasing the volume of the entire secondary battery. Details will be described below.

In order to solve the shortcomings of the conventional all-solid-state secondary battery, to increase uniformity of the internal pressure generated during battery operation, and to improve energy density by reducing a change in the overall thickness of the battery, The all-solid-state secondary battery 1 according to an embodiment, may include the elastomeric member 40 disposed (e.g., arranged) in at least one of the positive electrode current collector 11 or the negative electrode current collector 21.

The elastomeric member 40 may include at least one of a polymer and a polymer metal composite. The polymer included in the elastomeric member 40 may include, but is not necessarily limited to, a polymer containing silicon (SI), styrene butadiene rubber (SBR), polyurethane, ethylene propylene diene monomer (EDPM), butadiene rubber, etc. The elastomeric member 40 according to an embodiment may have elastic restoring force, which is described elsewhere herein.

The negative electrode active material layer 22 may further include a crystalline or amorphous carbon-containing (i.e., carbon-based) material. Conventional carbon-based materials may include, but are not necessarily limited to, for example, graphite, carbon black (CB), acetylene black (AB), furnace black (FB), Ketjen black (KB), graphene, carbon nanotubes, carbon nano fibers, etc., and any suitable carbon-based material such as those classified as carbon-based materials in the art may be used.

The negative electrode active material layer 22 may further include, for example, a metal oxide, a metal, or a combination thereof.

For example, the negative electrode active material layer 22 may simultaneously include a metal oxide, a metal, or a combination thereof. The metal oxide, metal or combination thereof further included in the negative electrode active material layer 22 may be supported on aligned carbon, but are not necessarily limited thereto. The metal oxide, the metal or the combination thereof, may be supported on the pores and/or channels of the aligned carbon, to thereby be uniformly distributed in the negative electrode active material layer 22.

In addition, the negative electrode active material layer 22 may include a carbon-based negative electrode active material, a mixture of a carbon-based negative electrode active material and at least one of a metal or a metalloid, a composite of a carbon-based negative electrode active material and at least one of a metal or a metalloid, or a combination thereof, but is not limited thereto.

The size of the metal oxide may be, for example, 1 nanometer (nm) to 1 micrometer (μm), 1 nm to 100 nm, 1 nm to 10 nm, 1 nm to 2 nm, 0.5 nm to 500 nm, or 1.5 nm to 300 nm. The sizes of the metal oxide particles may be, for example, an average particle diameter. The size of the metal oxide is, for example, an arithmetic average value of particle sizes obtained from scanning electron microscope images. The particle size is the particle diameter in the case of spherical particles, and the sizes of the non-spherical particles may correspond to the maximum value of the distance between both ends of any of the particles.

The metal oxide may be an oxide of a metal belonging to Groups III to XII of the Periodic Table of the Elements according to the International Union of Pure and Applied Chemistry (“IUPAC”). The metal oxide may include, for example, FeOₓ (0<x≤2), FeO, FeO₂, Fe₂O₃, Fe₃O₄, AlOₓ (0<x≤2), Al₂O₃, SnOₓ (0<x≤2), SnO, GeOₓ (0<x≤2), GeO, SiOₓ (0<x≤2), SiO, SiO₂, ScOₓ (0<x≤2), Sc₂O₃, CrOₓ (0<x≤5), CrO, Cr₂O₃, CrO₂, CrO₃, CrO₅, MnOₓ (0<x≤3), MnO, Mn₂O₃, Mn₃O₄, MnO₂, MnO₃, CoOₓ (0<x≤2), CoO, Co₂O₃, Co₃O₄, NiOₓ (0<x≤2), NiO, Ni₂O₃, CuOₓ (0<x≤2), CuO, CuO₂, Cu₂O₃, Cu₂O, or a combination thereof.

Metals may be derived from, for example, metal oxides. Metal may include, for example, Fe, Al, Sn, Ge, Si, Sc, Cr, Mn, Co, Ni, Cu, or a combination thereof. The metal may be, for example, generated in a supporting process of the metal oxide or derived from the metal oxide.

Meanwhile, the negative electrode active material layer 22 may further include, for example, a second metal, a second metalloid, a second metal oxide, a second metalloid oxide, or a combination thereof.

The negative electrode active material layer 22 may include predetermined carbon, and the carbon may further comprise, for example, a second metal, a second metalloid, a second metal oxide, a second metalloid oxide, or a combination thereof. The second metal, the second metalloid, the second metal oxide, the second metalloid oxide or the combination thereof may be disposed on, for example, a surface of the carbon. The second metal, the second metalloid, the second metal oxide, the second metalloid oxide or the combination thereof may be disposed on, for example, surfaces of a plurality of nano channels containing the carbon. The second metal is, for example, a metal negative electrode active material. The second metalloid is, for example, a metalloid negative electrode active material. The metal negative electrode active material and/or the metalloid negative electrode active material include, but are not necessarily limited to, for example, silver (Ag), tin (Sn), germanium (Ge), indium (In), silicon (Si), gallium (Ga), aluminum (Al), titanium (Ti), zirconium (Zr), niobium (Nb), antimony (Sb), bismuth (Bi), gold (Au), platinum (Pt), palladium (Pd), magnesium (Mg), zinc (Zn), alloys thereof, or combinations thereof, and any suitable metal or metalloid used as metal negative electrode active material or metalloid negative electrode active material that forms lithium alloys or lithium compounds in the art may be used. The second metal oxide is, for example, a metal oxide negative electrode active material. The metal oxide negative electrode active material is, for example, TiO₂. The second metalloid oxide is, for example, a metalloid oxide negative electrode active material. The metalloid oxide negative electrode active material is, for example, SiOₓ (0<x<2). The negative electrode active material layer 22 includes the second metal, the second metalloid, the second metal oxide, the second metalloid oxide, or the combination thereof, thereby further improving the charge capacity and/or discharge capacity of the all-solid-state secondary battery.

When the negative electrode active material layer 22 further includes, for example, a second metal, a second metalloid, a second metal oxide, a second metalloid oxide, or a combination thereof, a mixing ratio of a mixture of predetermined carbon and the second metal, for example, such as silver (Ag) may be, for example, about 10:1 to about 1:2, about 5:1 to about 1:1, or about 4:1 to about 2:1, based on a weight ratio, but is not necessarily limited to this range and is selected according to the characteristics of the desired all-solid-state secondary battery 1.

The positive electrode active material layer 22 may further include, for example, a binder (not shown). The binder includes, for example, styrene-butadiene rubber (SBR), carboxymethylcellulose (CMC), polytetrafluoroethylene, polyvinylidene fluoride, polyethylene, vinylidene fluoride/hexafluoropropylene copolymer, polyacrylonitrile, polymethylmethacrylate, or a combination thereof, but is not necessarily limited thereto, and any suitable material used as a binder in the art may be used. The binder may be composed of one type of a binder or a combination of two or more types of binders.

The all-solid-state secondary battery 1 according to an embodiment may further include a second negative electrode active material layer (not shown) disposed between the negative electrode current collection 21 and the negative electrode active material layer 22. The second negative electrode activity layer (not shown) may be a plated lithium layer, a non-plated lithium layer, a non-plated lithium alloyable metal layer, or a combination thereof. The plated lithium layer is a lithium layer precipitated during the charging process. The non-plated lithium layer is a lithium layer provided in a different way without being precipitated during the charging process. The non-plated lithium layer is, for example, a lithium foil or a lithium sheet. The non-plated lithium alloyable metal layer is a layer including a metal element other than lithium that is provided in a different way without being precipitated during the charging process. The non-plated lithium alloyable metal layer is a metal layer including gold, silver, zinc, tin, indium, silicon, aluminum, bismuth, etc.

The second negative electrode active material layer (not shown) may be disposed between the negative electrode current collector 21 and the negative electrode active material layer 22 by charging, for example, after the assembly of the all-solid-state secondary battery 1. Specifically, the charge capacity of the positive electrode active material layer 12 is set to be excessive than the charge capacity of the negative electrode active material layer 22. For example, the all-solid-state secondary battery 1 is charged, exceeding the charge capacity of the negative electrode active material layer 22. In other words, the negative electrode active material layer 22 is overcharged. In the early stages of charging, lithium is precipitated and/or absorbed within the negative electrode active material layer 22. That is, the predetermined carbon forms a compound with lithium ions moving from the positive electrode layer 10, forms lithium on the surface of the carbon, or precipitates lithium on the surface thereof. When the battery is further charged beyond the capacity of the negative electrode active material layer 22, lithium is precipitated on the back of the negative electrode material layer 22, that is, between the negative electrode current collector 21 and the negative electrode active material layer 22, and a second negative electrode active material layer (not shown) is formed by the lithium. That is, the plated lithium layer is arranged as a second negative electrode active material layer (not shown). The second negative electrode active material layer (not shown) is mainly composed of lithium metal, and may also include an additional element other than lithium. Such phenomena may occur when a negative electrode active material additionally includes an alloy of a specific material with lithium, or an alloy forming element that forms a compound. At the time of discharge, lithium inside the first negative electrode active material layer 22 and a lithium precipitation layer (not shown) ionize to move to the positive electrode layer 10. Therefore, in the all-solid-state secondary battery 1, the precipitated lithium may be used as a negative electrode active material. In addition, a lithium precipitation layer (not shown) is coated on the negative electrode active material layer 22, and thus, is applied as a protective layer of the negative electrode active material layer 22. Simultaneously, it is possible to inhibit the precipitation and growth of the lithium dendrite. As a result, the short circuit and capacity deterioration of the secondary battery 1 is inhibited, and the cycle characteristics of the secondary battery 1 are improved.

An oxide-containing (i.e., oxide-based) solid electrolyte, a sulfide-containing (i.e., sulfide-based) solid electrolyte, a polymer-containing (i.e., polymer-based) solid electrolyte, or a combination thereof, may be used as the solid electrolyte.

The oxide-based solid electrolyte may be in a crystalline state or may be in an amorphous state. In addition, the crystalline and amorphous materials may be mixed.

The sulfide-based solid electrolyte may be in a crystalline state or may be in an amorphous state. In addition, the crystalline and amorphous materials may be mixed.

The polymer-based solid electrolyte may be in a crystalline state or may be in an amorphous state. In addition, the crystalline and amorphous materials may be mixed.

The oxide-based solid electrolyte includes Li_{1+x+y}AlₓTi₂₋ₓSi_{y}P_{3-y}O₁₂ (0<x<2, 0≤y<3), BaTiO₃, Pb(ZrₚTi₁₋ₚ)O₃ (PZT, 0≤p≤1), Pb₁₋ₓLaₓZr_{1-y}Ti_{y}O₃ (PLZT, 0≤x<1, 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₚGa₁₋ₚ)ₓ(Ti_{q}Ge_{1-q})₂₋ₓSi_{y}P_{3-y}O₁₂ (0≤x≤1, 0≤y≤1, 0≤p≤1, and 0≤q≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, Zr, or a combination thereof, 0≤x≤10), Li₃₊ₓLa₃Zr_{2-y}M_{y}O₁₂ (M doped LLZO, M=Ga, W, Nb, Ta, Al, or a combination thereof, 0≤x≤10, 0<y<2), Li₇La₃Zr₂₋ₓTaₓO₁₂ (LLZ-Ta, 0<x<2), or a combination thereof. The oxide-based solid electrolyte is, for example, a garnet-based solid electrolyte.

The oxide-based solid electrolyte includes, for example, Li₇La₃Zr₂O₁₂ (LLZO) Li_{6.5}La₃Zr_{1.5}Ta_{0.5}O₁₂, Li_{1.3}Al_{0.3} Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, or a combination thereof.

The sulfide-based solid electrolyte includes, for example, at least one of Li₂S—P₂S₅, Li₂S—P₂S₅—LiX (X is an halogen element), Li₂S—P₂S₅—Li₂O, Li₂S—P₂S₅—Li₂O—LiI, Li₂S—SiS₂, Li₂S—SiS₂-LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each a positive number, and Z is f Ge, Zn, Ga, or a combination thereof), Li₂S—GeS₂, Li₂S—SiS₂—Li₃PO₄, Li₂S—SiS₂—LiₚMO_{q} (p and q are each a positive number, and M is P, Si, Ge, B, Al, Ga, In, or a combination thereof), Li₇₋ₓPS₆₋ₓClₓ (O≤x≤2), Li₇₋ₓPS₆₋ₓBrₓ (0≤x≤2), or Li₇₋ₓPS₆₋ₓIₓ (0≤x≤2). The sulfide-based solid electrolyte is manufactured by processing raw materials such as LI₂S and P₂S₅ by a melt quenching method, a mechanical milling method, or the like. In addition, after such processing, heat treatment may be performed. The sulfide-based solid electrolyte may be amorphous, crystalline, or a mixture thereof.

In addition, the sulfide-based solid electrolyte may include sulfur(S), phosphorus (P), and lithium (Li) as at least a component of the sulfide-based solid electrolyte material described above. For example, the sulfide-based solid electrolyte may be a material including Li₂S—P₂S₅. When using a material including Li₂S—P₂S₅ as a sulfide-based solid electrolyte material, the mixed molar ratio of Li₂S and P₂S₅, that is, Li₂S:P₂S₅ is, for example, in a range of about 50:50 to about 90:10. The sulfide-based solid electrolyte may include, for example, Li₇P₃S₁₁, Li₇PS₆, Li₄P₂S₆, Li₃PS₆, Li₃PS₄, Li₂P₂S₆, or a combination thereof.

The sulfide-based solid electrolyte may be an argyrodite-type compound including Li₇-xPS₆-xClₓ (0≤x≤2), Li₇-xPS₆-xBrₓ (0≤x≤2), Li₇-xPS₆-xIₓ (0≤x≤2), or a combination thereof. In particular, the sulfide-based solid electrolyte including a solid electrolyte may be an argyrodite-type compound including Li₆PS₅Cl, Li₆PS₅Br, Li₆PS₅I, or a combination thereof.

The polymer-based solid electrolyte may be, for example, a solid electrolyte including an ion conductive polymer and a lithium salt, a solid electrolyte including an ionic liquid polymer and a lithium salt, or a combination thereof.

The ion conductive polymer is a polymer containing an ion conductive repeating unit in a main chain or a side chain. The ion conductive repeating unit is a unit having ion conductivity, and may be, for example, an alkylene oxide unit, a hydrophilic unit, or the like. The ion conductive polymer may include, for example, an ether-based monomer, an acrylic monomer, a methacryl monomer, a siloxane-based monomer or a combination thereof as an ion conductive repeating unit. The ion conductive polymer may be, for example, polyethylene oxide, polypropylene oxide, polymethyl methacrylate, polyethyl methacrylate, polydimethylsiloxane, polyacrylic acid, polymethacrylic acid, polymethyl acrylate, polyethylacrylate, poly 2-ethylhexyl acrylate, polybutyl methacrylate, poly 2-ethylhexylmetacrylrate, polydesilacrylrate, polyethylene vinyl acetate, or a combination thereof. The ion conductive polymer may be, for example, polyethylene oxide (PEO), polyvinyl alcohol (PVA), polyvinylpyrrolidone (PVP), polyvinylsulfone, or a combination thereof.

A polymeric ionic liquid (PIL) may include a repeating unit including: For example, i) cations of ammonium-based, pyrrolidinium-based, pyridinium-based, pyrimidinyl-based, imidazolium-based, piperidinium-based, pyrazolium-based, oxazolium-based, pyridazinium-based, phosphonium-based, sulfonium-based, triazole-based, or a combination thereof; and ii) anions of BF₄—, PF₆—, AsF₆—, SbF₆—, AlCl₄—, HSO₄—, ClO₄—, CH₃SO₃—, CF₃CO₂—, (CF₃SO₂)₂N—, Cl—, Br—, I—, BF₄—, SO₄—, PF₆—, ClO₄—, CF₃SO₃—, CF₃CO₂—, (C₂F₅SO₂)₂N—, (C₂F₅SO₂)(CF₃SO₂)N—, NO₃-, Al₂Cl₇—, AsF₆—, SbF₆—, CF₃COO—, CH₃COO—, CF₃SO₃—, (CF₃SO₂)₃C—, (CF₃CF₂SO₂)₂N—, (CF₃)₂PF₄—, (CF₃)₃PF₃—, (CF₃)₄PF₂—, (CF₃)₅ PF—, (CF₃)₆P—, SF₅CF₂SO₃—, SF₅CHFCF₂SO₃—, CF₃CF₂(CF₃)₂CO—, (CF₃SO₂)₂CH—, (SF₅)₃C—, (O(CF₃)₂C₂(CF₃)₂O)₂PO—(CF₃SO₂)₂N—, or a combination thereof. The polymeric ionic liquid may be, for example, poly (diallyldimethylammonium trifluoromethanesulfonyl imide (TFSI)), poly (1-allyl-3-methylimidazolium trifluoromethanesulfonyl imide), poly(N-methyl-N-propyl piperidinium bis(trifluoromethanesulfonyl)imide), or a combination thereof.

The lithium salt may be, for example, LIPF₆, LIBF₄, LISbF₆, LIASF₆, LICIO₄, LiCF₃SO₃, Li(CF₃SO₂)₂N, LiC₄F₉SO₃, LiAIO₂, LiAlCl₄, LiN(C_{X}F₂ₓ₊₁SO₂) (C_{Y}F_{2y+1}SO₂) (1≤x≤20 and 1≤y≤20), LiCl, LiI, or a combination thereof.

The solid electrolyte layer 30 may further include a binder, for example. The binder included in the solid electrolyte layer 30 may be, for example, styrene butadiene rubber (SBR), polytetrafluoroethylene, polyvinylidene fluoride, polyethylene, or the like, but is not limited thereto, and any suitable material used as a binder in the field may be used. The binder of the solid electrolyte layer 30 may be homogeneous or different from the binder of the positive electrode active material layer 12 and the negative electrode active material layer 22.

The solid electrolyte layer 30 may be a solid electrolyte that contains only the oxide-based solid electrolyte described above. For example, the solid electrolyte 30 may be made of only an oxide-based solid electrolyte.

The solid electrolyte layer 30 may include, for example, a liquid-impermeable ion conductive composite membrane. The liquid-impermeable ion conductive composite membrane may include the oxide-based solid electrolyte, the composite of the oxide-based solid electrolyte and the ion conductive polymer, or a combination thereof. The ion conductive polymer may be, for example, polyethylene oxide (PEO), but is not necessarily limited thereto.

The positive electrode layer 10 includes the positive electrode current collector 11 and the positive electrode active material layer 12.

The positive electrode current collector 11 may be, for example, a plate, a foil, or the like made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, or a combination thereof. The positive electrode current collector 11 may be omitted.

The positive electrode active material layer 12 includes, for example, a positive electrode active material.

The positive electrode active material is a positive electrode active material capable of reversibly absorbing and desorbing lithium ions. The positive electrode active material may include, for example, a lithium transition metal oxide such as a lithium cobalt oxide (LCO), a lithium nickel oxide, a lithium nickel cobalt oxide, a lithium nickel cobalt aluminum oxide (NCA), a lithium nickel cobalt manganese oxide (NCM), a lithium manganese oxide, a lithium iron phosphate, or the like, a nickel sulfide, a copper sulfide, a lithium sulfide, an iron oxide, a vanadium oxide, or the like, but is not necessarily limited thereto, and any suitable material used as a positive electrode active material in the art may be used. The positive electrode active material may be one of the aforementioned materials, or a mixture of two or more types.

The positive electrode active material may include lithium salt of a transition metal oxide having a layered rock salt type structure among the lithium metal oxides described above. The layered rock salt type structure is a structure in which an oxygen atomic layer and a metal atomic layer are alternately and regularly arranged in a direction of, for example, a cubic rock salt type structure, whereby each atomic layer forms a two-dimensional plane. The cubic rock salt type structure represents a sodium chloride (NaCl) type structure, which is a kind of crystal structure, and specifically, having a structure in which face centered cubic lattices (fcc), which are respectively formed by cations and anions, is arranged to be misaligned by ½ of a ridge of a unit lattice. The lithium transition metal oxide having such a layered rock salt type structure is, for example, a ternary lithium transition metal oxide, such as, for example, LiNiₓCo_{y}Al_{z}O₂ (NCA) or LiNiₓCo_{y}Mn_{z}O₂ (NCM) (0<x<1, 0<y<1, 0<z<1, and x+y+z=1). The lithium transition metal oxide having such a layered rock salt type structure is, for example, a quaternary lithium transition metal oxide such as, for example, LiNiₓCo_{y}Mn_{z}Al_{w}O₂ (NCMA) (0<x<1, 0<y<1, 0<z<1, 0<w<1, and x+y+z+w=1). In addition, the lithium salt of the transition metal oxide having the layered rock salt type structure may have a high nickel content. For example, the lithium salt of the transition metal oxide having the layered rock salt type structure may be a lithium salt of a ternary or quaternary transition metal oxide having a high nickel content, such as, for example, LiNiₐCo_{b}Al_{c}O₂ (0.5<a<1, 0<b<0.3, 0<c<0.3, and a+b+c=1), LiNiₐCo_{b}Mn_{c}O₂ (0.5<a<1, 0<b<0.3, 0<c<0.3, and a+b+c=1) or LiNiₐCo_{b}Mn_{c}Al_{d}O₂ (0.5<a<1, 0<b<0.3, 0<c<0.3, 0<c<0.3, and a+b+c+d=1). When the positive electrode active material includes a ternary lithium transition metal oxide having a layered rock salt type structure, the energy density and thermal stability of the all-solid-state secondary battery 1 are further improved.

Referring to FIG. 2, provided is an all-solid-state secondary battery 2 in which the all-solid-state secondary batteries 1 described in FIG. 1 are disposed to face each other.

A first positive electrode active material layer 12a, a first solid electrolyte layer 30a, a first negative electrode layer 20a and a first elastomeric member 40a may be disposed facing a second positive electrode active material layer 12b, a second solid electrolyte layer 30b, a second negative electrode layer 20b, and a second elastomeric member 40b, respectively, around positive electrode current collectors 11a and 11b. In an aspect, the positive electrode current collector 11a may be the positive electrode current collector 11b.

Specifically, the lower portion of the all-solid-state secondary battery 2 includes: a first positive electrode layer 10a; a first negative electrode layer 20a; and a first solid electrolyte layer 30a disposed between the first positive electrode layer and the first negative electrode layer. Here, the first negative electrode layer 20a may include a first negative electrode current collector 21a and a first negative electrode active material layer 22a, and the first positive electrode layer 10a may include a first positive electrode current collector 11a and a first positive electrode active material layer 12a. The first negative electrode current collector 21a and the first negative electrode active material layer 22a are included in the first negative electrode layer 20a and may be disposed side by side or in order in a thickness direction of the first negative electrode layer 20a. The first elastomeric member 40a may be disposed inside the first negative electrode current collector 21a. The second positive electrode layer 10b may be disposed opposite to the first positive electrode layer 10a, the second negative electrode layer 20b may be disposed opposite to the first negative electrode layer 20a, the second solid electrolyte layer 30b may be disposed opposite to the first solid electrolyte layer 30a, and the second elastomeric member 40b may be disposed opposite to the first elastomeric member 40a. The all-solid-state secondary battery 2 including the components described above may be provided.

Specifically, the all-solid-state secondary battery 2 disclosed in FIG. 2 may include both the first elastomeric member 40a and the second elastomeric member 40b, and the elastomeric members 40a and 40b each may be disposed inside the negative electrode current collectors 21a and 21b, respectively, and may have elastic restoring force. The elastic restoring force may be determined by Young's modulus of the elastomeric member 40 and will be described in detail below.

The Young's modulus of a material is an elastic property of a solid exhibiting inherent stiffness of the material, and may also be referred to as an elastic modulus and a tensile modulus in a tensile strain. The Young's modulus of the all-solid-state secondary battery according to an embodiment may be determined by a proportion of an internal pressure of the battery with respect to a volume change rate of the battery. For example, when the internal pressure of the battery is 0.6 megapascal (MPa) and the battery volume change rate is 12%, the Young's modulus may be 5 MPa that is obtained by dividing 0.6 by 0.12. The Young's modulus of the elastomeric member included in the all-solid-state secondary battery according to the embodiment may be about 10 MPa or less, preferably about 5 MPa or less, for example about 0.1 MPa to about 10 MPa, about 1 MPa to about 8 MPa, or about 2 MPa to about 5 MPa.

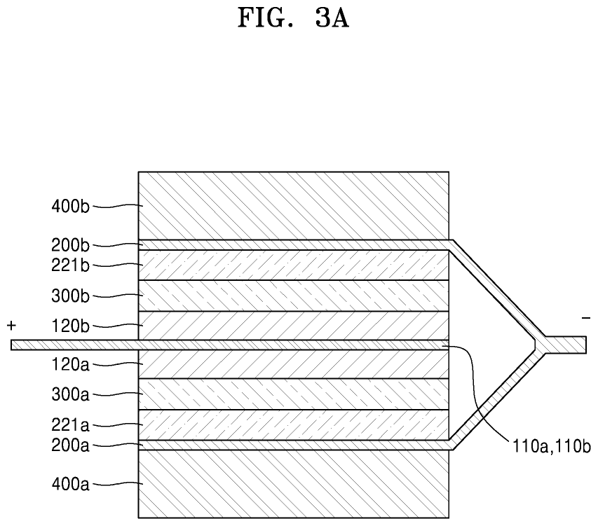

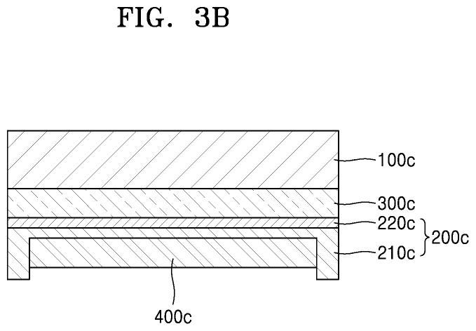

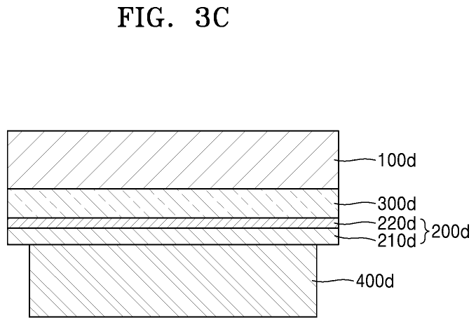

FIGS. 3A to 3C are each a cross-sectional view illustrating an all-solid-state secondary battery;

Referring to FIG. 3A, the elastomeric members 400a and 400b for alleviating the internal pressure of the battery may be disposed outside the negative electrode current collectors 200a and 200b, and the positive electrode layers. As mentioned above, when the elastomeric member is placed outside the current collector, the entire secondary battery volume increases and the thickness is increased, which may be disadvantageous in terms of high density integration. 110a and 110b represent positive electrode current collectors, 221a and 221b represent lithium layers, and 300a and 300b represent solid electrolyte layers.

Referring to FIG. 3B, the elastomeric member 400c may be disposed on one surface of the negative electrode current collector 210C, not inside of the negative electrode current collector 210C, and the opposite surface of the one surface of the negative electrode current collector 210C is in contact with the negative active material layer 220c. 100c represents the positive electrode layer, and 300c represents the solid electrolyte layer, and 200c represents the negative electrode layer. While not wishing to be bound by theory, the elastomeric member 400c may be disposed on the negative electrode current collector 210c because an open surface of the elastomeric member may be due to an electrical short-circuit caused by the volume expansion of the negative electrode active material layer due to lithium generated during the charging.

Referring to FIG. 3C, an elastomeric member 400d may be disposed on one surface of the negative electrode layer 200d, that is, an outer portion of the negative electrode current collector 210d. 100d represents the positive electrode layer, 210d represents the negative electrode current collector, 220d represents the negative active material layer, and 300d represents the solid electrolyte layer (110d is not shown in FIG. 3C). As mentioned above, when the elastomeric member is placed outside the current collector, the entire secondary battery volume increases and the thickness is increased, which may be disadvantageous in terms of high density integration.

As a result of estimating the unit thickness and charging and discharge efficiency of the battery of FIGS. 3A to 3C, it may be observed that the unit thickness of the battery is thicker or the charging and discharge efficiency is significantly less than that of the all-solid-state secondary battery shown in FIGS. 1 and 2.

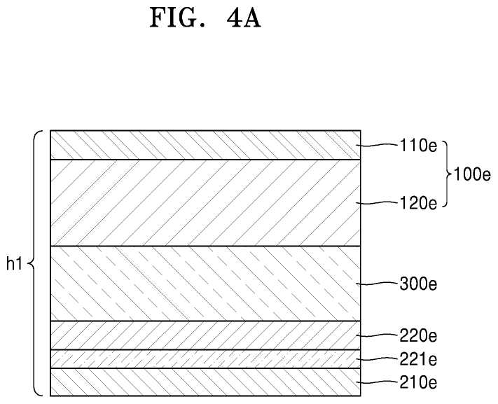

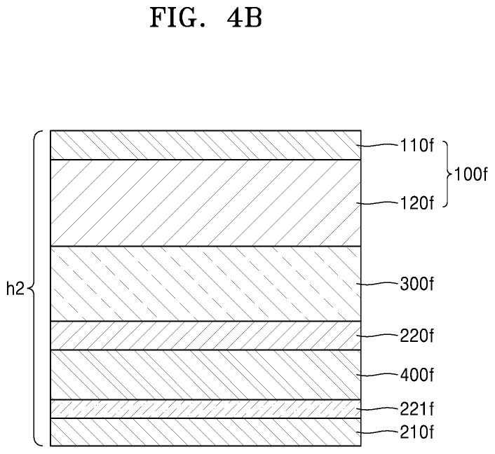

FIGS. 4A and 4B are each a cross-sectional view illustrating an all-solid-state secondary battery, wherein the all-solid state secondary battery of FIG. 4B includes an elastomer.

Referring to FIGS. 4A and 4B, all-solid-state secondary batteries include negative electrode current collectors 210e and 210f, negative electrode active material layers 220e and 220f, precipitated lithium layers 221e and 221f, positive electrode current collectors 110e and 110f, positive electrode active material layers 120e and 120f, solid electrolyte layers 300e and 300f, and an elastomeric member 400f.

Specifically, the thickness h1 of the secondary battery disclosed in FIG. 4A and the thickness h2 of the secondary battery disclosed in FIG. 4B may be different from each other. The secondary battery of FIG. 4B may include the elastomeric member 400f whereas the secondary battery of FIG. 4A does not include the elastomeric member. An elastic restoring force of the elastomeric member 400f inside the battery of FIG. 4B may be calculated from the internal pressure of the battery and the volume change of the battery. Compared to h1, h2 may be greater by about 12%, and when the Young's modulus of the elastomeric member is calculated based on experimental results, the Young's modulus of the secondary battery comprising the elastomeric member may be about 5 MPa or less, or about 10 MPa or less.

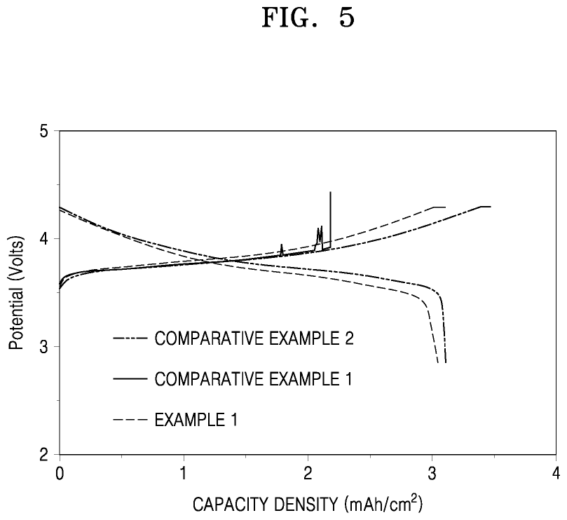

FIG. 5 is a graph illustrating charge/discharge characteristics according to capacitance per unit area used in Example 1 and Comparative Examples 1 and 2. Example 1 represents the charge/discharge characteristics of the all-solid-state secondary battery 1 described in FIG. 1, with repeated charging and discharging processes twice under the same condition. Comparative Examples 1 and 2 each represents the charge/discharge characteristics of the all-solid-state secondary battery described in FIG. 3B, with repeated charging and discharging processes twice under the same condition. Particularly, Comparative Example 2 shows that a short circuit occurs during charging.

Referring to FIG. 5, it can be seen that the all-solid-state secondary battery of Example 1 shows stable charging and discharging during repeated charging and discharging processes as compared with the all-solid-state secondary batteries of Comparative Examples 1 and 2.

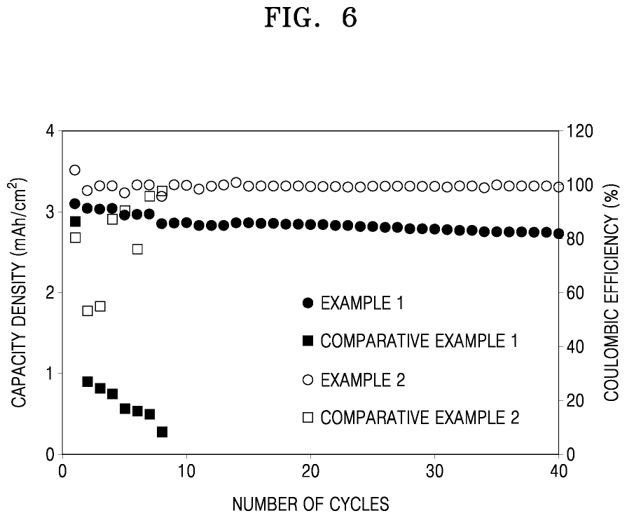

As shown in FIG. 6, the all-solid-state secondary batteries of Examples 1 and 2 have improved capacity retention compared to the all-solid-state secondary battery of Comparative Example 1 of FIG. 6 and the all-solid-state secondary battery of Comparative Example 2 of FIG. 6. Example 1 represents the battery capacity per area according to the number of cycles of charging and discharging processes of the all-solid-state secondary battery 1 described in FIG. 1. Example 2 represents the Coulombic Efficiency according to the number of cycles of charging and discharging processes of the all-solid-state secondary battery 1 described in FIG. 1. Comparative Example 1 represents the battery capacity per area according to the number of cycles of charging and discharging processes of the all-solid-state secondary battery described in FIG. 3B. Comparative Example 2 represents the Coulombic Efficiency according to the number of cycles of charging and discharging processes of the all-solid-state secondary battery described in FIG. 3B.

The all-solid-state secondary battery according to an embodiment includes a positive electrode layer including a positive electrode active material layer and a positive electrode current collector, a negative electrode layer spaced apart from the positive electrode layer and including a negative electrode current collector and a negative electrode active material layer, a solid electrolyte layer disposed between the positive electrode layer and the negative electrode layer, and an elastomeric member comprising an elastomer disposed inside at least one of the negative electrode current collector or the positive electrode current collector, wherein the negative electrode current collector and the negative electrode active material layer are disposed side by side in a thickness direction of the negative electrode layer, the positive electrode current collector and the positive electrode active material layer are disposed side by side in a thickness direction of the positive electrode layer, and at least one of the negative electrode current collector or the positive electrode current collector surrounds an outer surface of the elastomer.

The all-solid-state secondary battery including an elastomeric member according to an embodiment may relieve the internal pressure generated during the charging and discharge process of the battery by disposing an entire elastomeric member in a negative electrode current collector, and may secure high energy density and improve coulombic efficiency by preventing an increase in the entire volume of the battery.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An all-solid-state secondary battery comprising:
a positive electrode layer comprising
a positive electrode active material layer, and
a positive electrode current collector;
a negative electrode layer spaced apart from the positive electrode layer and comprising
a negative electrode current collector, and
a negative electrode active material layer;
a solid electrolyte layer disposed between the positive electrode layer and the negative electrode layer; and
an elastomeric member comprising an elastomer and disposed inside at least one of the negative electrode current collector or the positive electrode current collector, wherein
the negative electrode current collector and the negative electrode active material layer are disposed side by side in a thickness direction of the negative electrode layer,
the positive electrode current collector and the positive electrode active material layer are disposed side by side in a thickness direction of the positive electrode layer, and
at least one of the negative electrode current collector or the positive electrode current collector surrounds an outer surface of the elastomeric member.

2. The all-solid-state secondary battery of claim 1, wherein at least one of the negative electrode current collector or the positive electrode current collector surrounds all outer surfaces of the elastomeric member.

3. The all-solid-state secondary battery of claim 1, wherein the elastomeric member comprises at least one of a polymer or a polymer metal composite.

4. The all-solid-state secondary battery of claim 1, wherein the elastomeric member is disposed inside the negative electrode current collector and has an elastic restoring force.

5. The all-solid-state secondary battery of claim 1, wherein the elastomeric member has a Young's modulus of 10 megapascals or less.

6. The all-solid-state secondary battery of claim 5, wherein the elastomeric member has a Young's modulus of 5 megapascals or less.

7. The all-solid-state secondary battery of claim 1, wherein a thickness of the elastomeric member is about 20 micrometers to about 100 micrometers.

8. The all-solid-state secondary battery of claim 1, wherein the at least one of the negative electrode current collector or the positive electrode current collector comprises a metal oxide, a metal, or a combination thereof.

9. The all-solid-state secondary battery of claim 1, wherein the negative electrode active material layer comprises
a carbon-containing negative electrode active material,
a mixture of a carbon-containing negative electrode active material and at least one of a metal or a metalloid,
a composite of a carbon-containing negative electrode active material and at least one of a metal or a metalloid, or
a combination thereof.

10. The all-solid-state secondary battery of claim 1, wherein a thickness of the negative electrode current collector is about 100 nanometers to about 30 micrometers.

11. The all-solid-state secondary battery of claim 8, wherein the metal oxide comprises FeOₓ wherein 0<x≤2, FeO, FeO₂, Fe₂O₃, Fe₃O₄, AlOₓ wherein 0<x≤2, Al₂O₃, SnOₓ wherein 0<x≤2,SnO, GeOₓ wherein 0<x≤2, GeO, SiOₓ wherein 0<x≤2, SiO, SiO₂, ScOₓ wherein 0<x≤2, Sc₂O₃, CrOₓ wherein 0<x≤5, CrO, Cr₂O₃, CrO₂, CrO₃, CrO₅, MnOₓ wherein 0<x≤3, MnO, Mn₂O₃, Mn₃O₄, MnO₂, MnO₃, CoOₓ wherein 0<x≤2, CoO, Co₂O₃, Co₃O₄, NiOₓ wherein 0<x≤2, NiO, Ni₂O₃, CuOₓ wherein 0<x≤2, CuO, CuO₂, Cu₂O₃, Cu₂O, or a combination thereof.

12. The all-solid-state secondary battery of claim 8, wherein the metal is derived from the metal oxide, and the metal comprises at least one of Cu, Ni, Ag, Fe, Ti, or Cr.

13. The all-solid-state secondary battery of claim 1, wherein
a first positive electrode active material layer, a first solid electrolyte layer, a first negative electrode layer, and a first elastomeric member are disposed on a first surface of the positive electrode current collector,
a second positive electrode active material layer, a second solid electrolyte layer, a second negative electrode layer, and a second elastomeric member are disposed on a second surface of the positive electrode current collector, the second surface being opposite to the first surface of the positive electrode current collector, and
the first positive electrode active material layer, the first solid electrolyte layer, the first negative electrode layer, and the first elastomeric member are disposed opposite to the second positive electrode active material layer, the second solid electrolyte layer, the second negative electrode layer, and the second elastomeric member, respectively, with respect to the positive electrode current collector.

14. The all-solid-state secondary battery of claim 1, wherein the solid electrolyte layer comprises an oxide-containing solid electrolyte, a sulfide-containing solid electrolyte, a polymer-containing solid electrolyte, or a combination thereof.

15. The all-solid-state secondary battery of claim 14, wherein the oxide-containing solid electrolyte comprises Li_{1+x+y}AlₓTi₂-xSi_{y}P_{3-y}O₁₂ wherein 0<x<2 and 0≤y<3, BaTiO₃, Pb (ZrₚTi₁₋ₚ)O₃ wherein 0≤p≤1, Pb₁₋ₓLaₓZr_{1-y}Ti_{y}O₃ wherein 0≤x<1 and 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(AlₚGa₁₋ₚ)ₓ(Ti_{q}Ge_{1-q})₂₋ₓSi_{y}P_{3-y}O₁₂ wherein 0≤x≤1, 0≤y≤1, 0≤p≤1, and 0≤q≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂ wherein M is Te, Nb, Zr, or a combination thereof, and 0≤x≤10, Li₃₊ₓLa₃Zr_{2-y}M_{y}O₁₂ wherein M is Ga, W, Nb, Ta, Al, or a combination thereof, 0≤x≤10, and 0<y<2, Li₇La₃Zr₂₋ₓTaₓO₁₂ wherein 0<x<2, or a combination thereof.

16. The all-solid-state secondary battery of claim 14, wherein the oxide-solid electrolyte containing comprises Li₇La₃Zr₂O₁₂, Li_{6.5}La₃Zr_{1.5}Ta_{0.5}O₁₂, Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, or a combination thereof.

17. The all-solid-state secondary battery of claim 14, wherein the sulfide-containing solid electrolyte comprises Li₂S—P₂S₅, Li₂S—P₂S₅—LiX wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ wherein m and n are each a positive number, and Z is Ge, Zn, Ga, or a combination thereof, Li₂S—GeS₂, Li₂S—SiS₂—Li₃PO₄, Li₂S—SiS₂-LiₚMO_{q} wherein p and q are each a positive number, and M is P, Si, Ge, B, Al, Ga, In, or a combination thereof; or a combination thereof.

18. The all-solid-state secondary battery of claim 1, wherein a second negative electrode active material layer is further disposed between the negative electrode current collector and the negative electrode active material layer.
